(19) United States
(12) Patent Application Publication
(10) Pub. No.: US 2006/0090295 A1
(43) Pub. Date: May 4, 2006

(54) Hinge for a folding door

(76) Inventor: Claus Hofer, Fussach (AT)

Correspondence Address: WENDEROTH, LIND & PONACK, L.L.P., 2033 K STREET N. W., SUITE 800, WASHINGTON, DC, 20006-1021, US

(21) Appl. No.: 11/251,935

(22) Filed: Oct. 18, 2005

(30) Foreign Application Priority Data
Oct. 28, 2004 (AT) A 1815/2004

(51) Int. Cl. E05D 7/04

(52) U.S. Cl. 16/237

(57) ABSTRACT

A hinge for a folding door, in particular for movable furniture parts (4, 11), having at least one abutment part (1) with a first region (2) for securing to a furniture part (4) or the like and a second region (3) which is at an angle thereto and is adjustable in length, in which for the purpose of adjustment in length in the second region (3), a transmission device (5) for converting a rotary movement into a longitudinal movement is provided.

The present invention relates to a hinge for a folding door, in particular for movable furniture parts, having at least one abutment part with a first region for securing to a furniture part or the like and a second region which is at an angle thereto and is adjustable in length.

Hinges for folding doors are used to connect in pivotal manner two movable furniture parts which form for example the door in the region of a returning corner of a fitted kitchen or the like. For this reason, they are suitable for reaching around a reflex angle. So that a hinge for a folding door can be used for different panel thicknesses of the furniture parts, a tilted adjustment, as it is called, is already known. This is created in the case of the prior art in the second region of the abutment part, which is at an angle and is adjustable in length, as a combination of elongate hole and clamping screw. Fine teeth have to be provided in the elongate hole so that locking can be maintained with stability. To make an adjustment, first of all the clamping screw has to be loosened and then the adjustment performed, and thereafter the clamping screw has to be tightened again. This is very cumbersome. Moreover, as a rule at least two hinges have to be adjusted in the same way at the same time, which because of the need to loosen the clamping screws results in an unstable intermediate condition. A further disadvantage consists in the fact that stepless variable adjustment is not possible because of the need for teeth in the elongate hole.

It is therefore the object of the invention to improve the above-described tilted adjustment for hinges for folding doors such that a stepless adjustment which is as simple as possible is made possible.

In accordance with the invention, this is achieved in that, for the purpose of adjustment in length in the second region, a transmission device for converting a rotary movement into a longitudinal movement is provided.

As a result of the transmission device for converting a rotary movement into a longitudinal movement, for the purpose of making a tilted adjustment it is no longer necessary to loosen a clamping screw and tighten it again. The hinge for a folding door and the furniture parts which are secured thereto remain in a stable position with respect to one another throughout the adjustment procedure. Moreover, the transmission device according to the invention also makes it possible to perform a stepless tilted adjustment. In this connection, it is particularly advantageous if the transmission device is self-locking, that is to say that it remains in any position, once adopted, without further measures. The transmission device is advantageously arranged directly in the second region of the abutment part, that in which the adjustment in length is to be performed.

Various embodiments and further advantages of the invention will be explained with reference to the attached figures, in which:

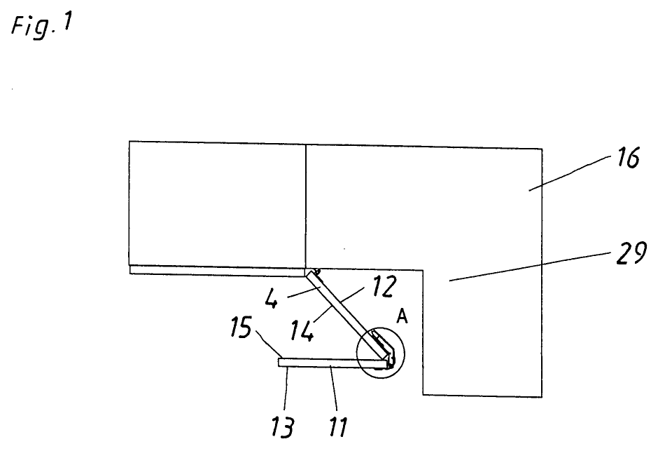

FIG. 1 shows a typical installation situation for a hinge for a folding door,

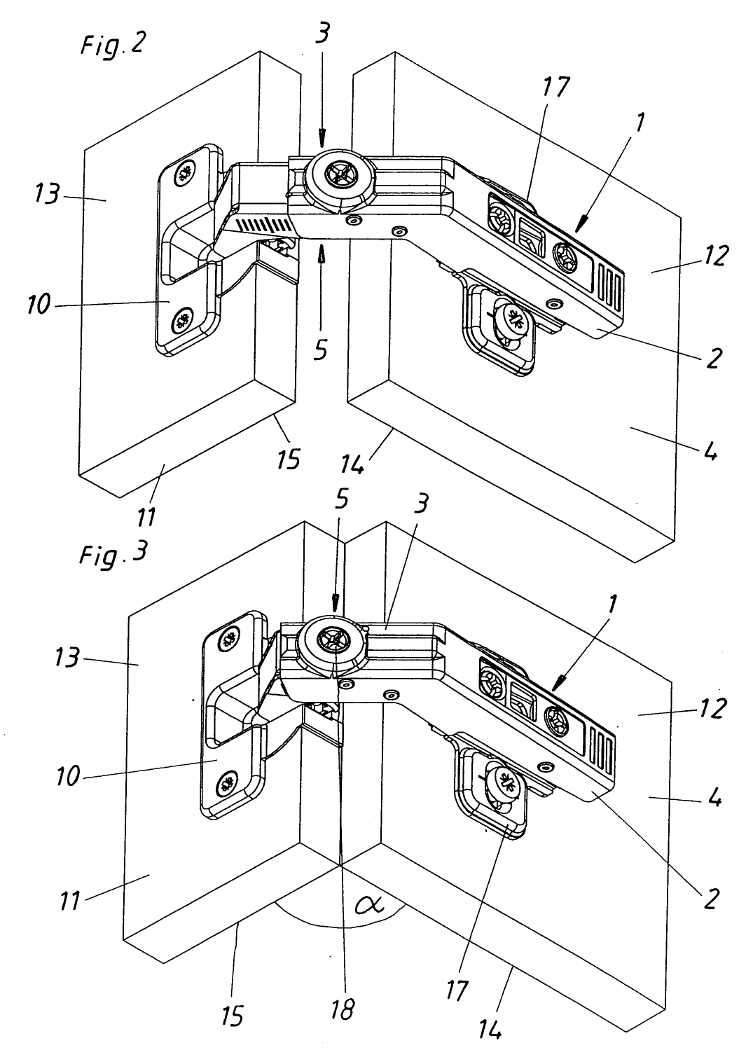

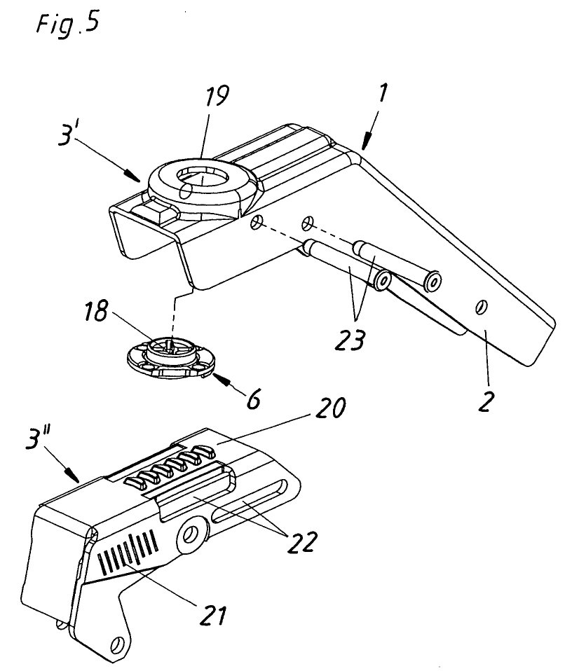

FIGS. 2 to 5 show a first example embodiment of the invention,

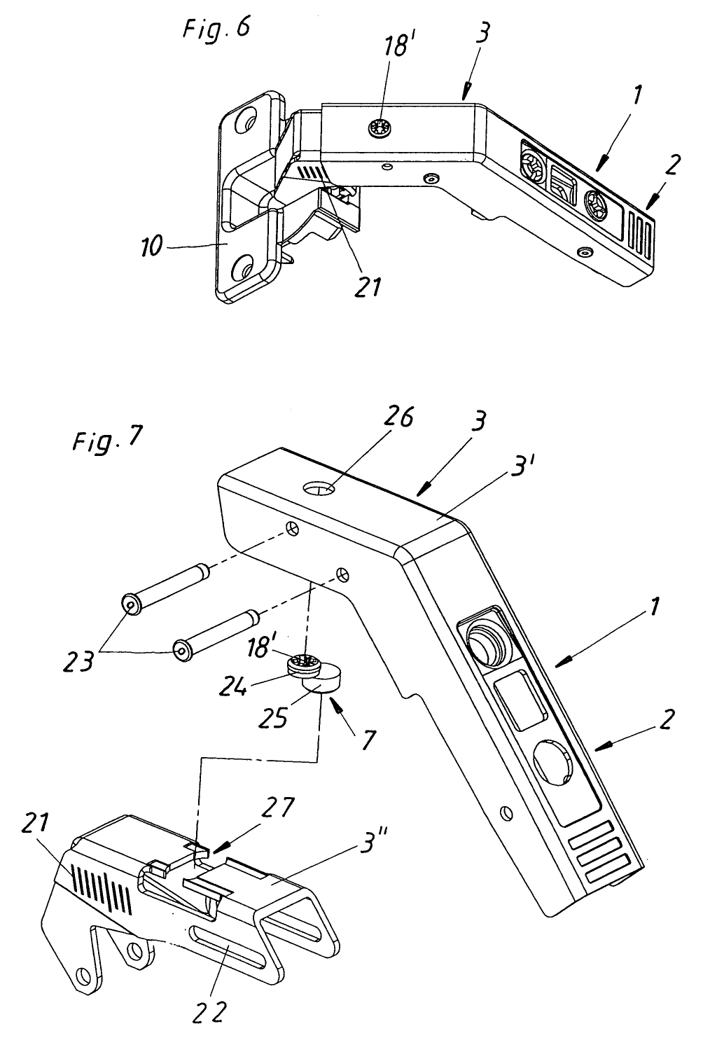

FIGS. 6 and 7 show a second example embodiment of the invention, and

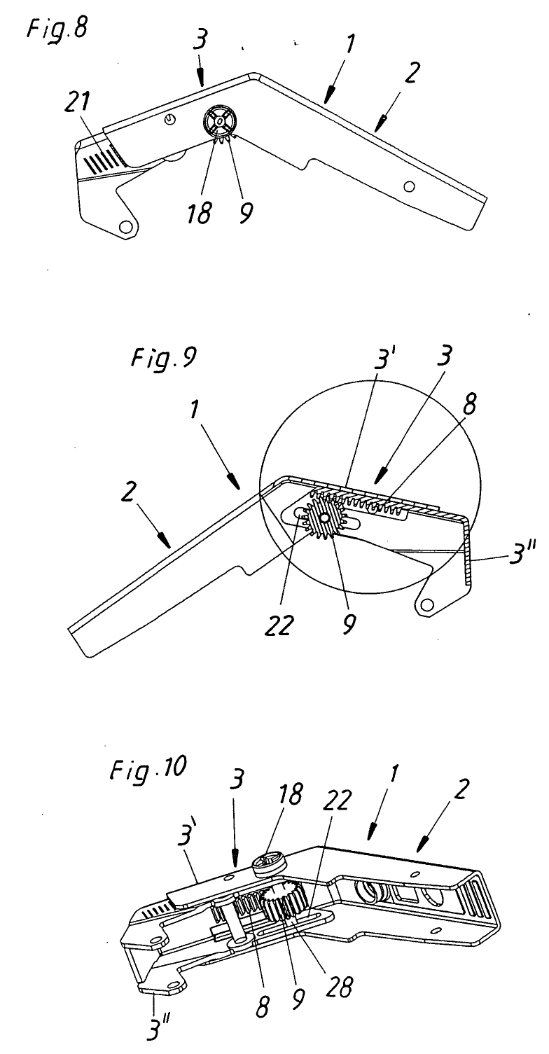

FIGS. 8 to 10 show the parts which are essential to the invention, in a third example embodiment of the invention.

FIG. 1 shows a corner cabinet 16 whereof the returning corner 29 may be closed off by the movable furniture parts 4 and 11. Between these two furniture parts there is arranged, for this purpose, a hinge for a folding door in the region A. This connects the two furniture parts 4 and 11 to one another such that, when the abutment parts 1 and 10 of the hinge for the folding door are mounted on the respective rear sides 12 and 13 of the furniture parts 4 and 11, the front sides 14 and 15 of the furniture parts 4 and 11, which are opposed to the rear sides 12 and 13, enclose an angle α of substantially 90° with one another in at least one end position, in this case the closed position. If the corner cabinets 16 or the like have a different shape, another angle smaller than 180° between the two front sides 14 and 15 may be provided for. A comparison between FIGS. 2 and 3 shows the main function of the tilted adjustment. Thus, by means of the tilted adjustment, the spacing between the furniture parts 4 and 11 can be adjusted so that, for example, an adjustment to different panel thicknesses of the furniture parts becomes possible. FIG. 3 shows, although in a perspective illustration, the angle α between the fronts 14 and 15 of the furniture parts 4 and 11.

In this example embodiment, as in the others, the hinge arm 1 and the hinge cup 10 are provided as abutment parts. The pivotal connection between the hinge arm and the hinge cup, or the abutment parts, may take the same form as that known from the prior art. The hinge arm 1 may be clipped onto a base plate 17, as in this example embodiment. These embodiments of the abutment parts should be seen only as examples, however. The essential point for a hinge for a folding door is that an abutment part—in this case the hinge arm 1—has a first region 2 for securing to a furniture part 4 or the like and a second region 3 which is at an angle thereto and which is in turn adjustable in length. The length adjustment of the region 3 is achieved through the transmission device 5 according to the invention, for converting a rotary movement into a longitudinal movement.

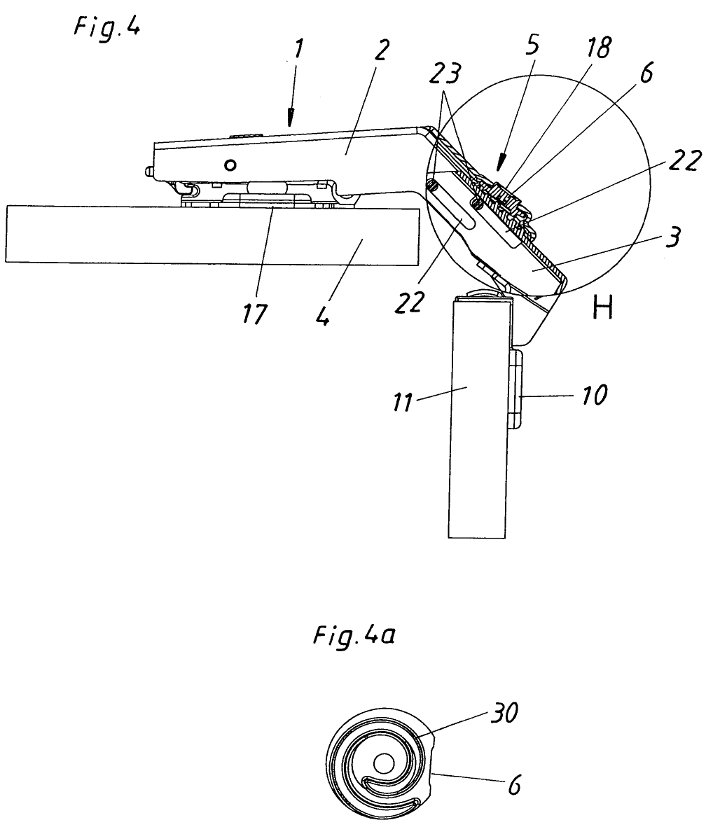

In the first example embodiment, in accordance with FIGS. 2 to 5, the transmission device 5 has as an essential component a spiral-shaped link piece 6. The second region 3 of the abutment part 1 is constructed in two pieces in the examples shown. It has two mutually displaceable, substantially U-shaped profiled pieces 3′ and 3″. Two guide slits 22 in which the guide pins 23 of the component 3′ engage are arranged in the component 3″. In the arrangement in which mounting is complete, the two components 3′ and 3″ are thus mutually displaceable along the guide slits 22, which is a prerequisite for the length adjustment in the region 3 of the abutment part 1. So that the desired stepless and very easily performed adjustment in length is made possible in accordance with the invention, in this example embodiment the spiral-shaped link piece 6, which is mounted in the guide housing 19 of the component 3′, engages in the teeth 20 which are provided on the component 3″. The spiral-shaped link piece 6 is rotated with the aid of the slot 18, into which a screwdriver, for example, can be inserted. As a result of rotating the spiral-shaped link pieces 6 in the teeth 20, the two components 3′ and 3″ are displaced relative to one another. So that this kind of adjustment in length or angular adjustment can be performed with precision, in addition a marking 21 can be provided, for example on the component 3″. In FIG. 4, the region 3 is illustrated in section as a detail H. FIG. 4a shows a view from below on the turns 30 of the spiral-shaped link piece, by means of which the spiral-shaped link piece 6 engages in the teeth 20. It is possible to obtain a self-locking construction of this example embodiment as a result of a correspondingly narrow seating of the two components 3′ and 3″ on one another in conjunction with the spiral-shaped link piece 6. The angle made between the first region 2 and the second region 3 of the abutment part 1 is substantially 45° in this case. However, other angles, for example between 40° and 50°, may also be provided.

FIGS. 6 and 7 show an alternative to the transmission device 5 having the spiral-shaped link piece 6. In this case, the transmission device 5 has as an essential component an eccentric 7. The two components 3′ and 3″ are guided in one another in the same way as that described for the first example embodiment. The eccentric 7 has a first cylindrical component 24 and a second cylindrical component 25 which are secured to one another fixedly or rigidly. The first cylindrical component 24 is seated rotatably in the hole 26 in the component 3′. So that actuation can be performed by means of a screwdriver, once again slots 18′ are provided. It goes without saying that—as in the other example embodiments—corresponding receivers for hexagonal socket keys or a different tool may be arranged in the component 24, as an alternative. The second cylindrical component 25 of the eccentric 7 is guided in the recess 27 in the second component 3″. As a result of rotating the first component 24, the second component 25, which is rigidly connected thereto, is rotated in the recess 27, which results overall in a relative displacement of the components 3′ and 3″ along the guide slits 22 and hence in an adjustment of the length of the second region 3 of the abutment part 1.

FIGS. 8 to 10 show an abutment part of a further hinge according to the invention. The other components of the hinge have been omitted from the illustration but may be constructed in the same way as in the other example embodiments. In this example embodiment, the adjustment in length is possible using a toothed wheel 9 which engages in a toothed rack 8. The toothed wheel 9 is arranged in the interior of the components 3′ and 3″, which have a U-shaped profile, and is fixed in its position relative to the outer component 3′ by the shaft 28. The toothing 8 is arranged on the second component 3″. When the toothed wheel 9 is rotated, because it engages the toothed rack 8, the two components 3′ and 3″ are displaced relative to one another and hence there is an adjustment in length in the region 3. So that the toothed wheel 9 can be rotated, once again, as in the other example embodiments, a slotted head 18 may be provided into which a screwdriver may be inserted. The slotted head 18, like the toothed wheel 9, is for this purpose arranged on a common shaft 28. The shaft 28 at the same time serves as a guide pin in the guide slit 22.

All the example embodiments are advantageously constructed to be self-locking, as a result of a correspondingly narrow seating of the components 3′ and 3″ on one another and the associated friction. The length of the second region 3, once it has been adjusted by means of the transmission device 5 for the purpose of converting a rotary movement into a longitudinal movement, is then maintained unchanged until the next adjustment is made deliberately. Should particularly large ranges of adjustment in length be desired, those solutions in accordance with the invention which have a spiral-shaped link track 6 or a toothed wheel 9 that engages in a toothed rack 8 are particularly suitable.

What is claimed is:

1. A hinge for a folding door, having at least one abutment part with a first region for securing to a furniture part or the like and a second region which is at an angle thereto and is adjustable in length, wherein for the purpose of adjustment in length in the second region, a transmission device for converting a rotary movement into a longitudinal movement is provided.

2. A hinge for a folding door as claimed in claim 1, wherein the transmission device is self-locking.

3. A hinge for a folding door as claimed in claim 1, wherein the transmission device is arranged in the second region of the abutment part.

4. A hinge for a folding door as claimed in claim 1, wherein the transmission device has a spiral-shaped link piece.

5. A hinge for a folding door as claimed in claim 1, wherein the transmission device has an eccentric.

6. A hinge for a folding door as claimed in claim 1, wherein the transmission device has a toothed wheel which engages in at least one toothed rack.

7. A hinge for a folding door as claimed in claim 1, wherein the first and the second regions enclose an angle of between 400 and 500 with one another.

8. A hinge for a folding door as claimed in claim 1, wherein the first and the second region enclose an angle of substantially 45° with one another.

9. A hinge for a folding door as claimed in claim 1, having two abutment parts, wherein it is suitable for connecting two mutually movable furniture parts to one another such that, when the abutment parts are mounted on the respective rear sides of the furniture parts, the front sides of the furniture parts, which are opposed to the rear sides, enclose an angle which is smaller than 180° with one another in at least one end position.

10. A hinge for a folding door as claimed in claim 1, having two abutment parts, wherein it is suitable for connecting two mutually movable furniture parts to one another such that, when the abutment parts are mounted on the respective rear sides of the furniture parts, the front sides of the furniture parts, which are opposed to the rear sides, enclose an angle of substantially 90° with one another in at least one end position.

11. A hinge for a folding door as claimed in claim 1, wherein it has a hinge arm as abutment part and a hinge cup as the abutment part.

12. A hinge for a folding door as claimed in claim 11, wherein the second region which is adjustable in length is part of the hinge arm.

13. A hinge for a folding door as claimed in claim 1, wherein the hinge is made for movable furniture parts.
